(19) United States
(12) Patent Application Publication
(10) Pub. No.: US 2013/0037423 A1
(43) Pub. Date: Feb. 14, 2013

(54) Multi-Point Cellular Analysis

(71) Applicants: Michael G. Schrlau, Drexel Hill, PA (US); Eugen Brailoiu, Cheltenham, PA (US); Nae J. Dun, Philadelphia, PA (US); Haim H. Bau, Swarthmore, PA (US)

(72) Inventors: Michael G. Schrlau, Drexel Hill, PA (US); Eugen Brailoiu, Cheltenham, PA (US); Nae J. Dun, Philadelphia, PA (US); Haim H. Bau, Swarthmore, PA (US)

(21) Appl. No.: 13/421,944

(22) Filed: Mar. 16, 2012

Related U.S. Application Data
(60) Provisional application No. 61/453,670, filed on Mar. 17, 2011.

(51) Int. Cl. G01N 27/26

(52) U.S. Cl. 205/780.5; 205/792; 205/789; 204/403.01

(57) ABSTRACT

Provided are devices and methods for performing multi-point analysis on biological materials, such as cells. In one embodiment, the devices simultaneously collect information related to a characteristic of a cell membrane and a characteristic of the interior of the cell.

### RELATED APPLICATION

The present application claims priority to U.S. Application No. 61/453,670, “Multi-Point Cellular Analysis,” filed on Mar. 17, 2011, the entirety of which application is incorporated herein by reference for any and all purposes.

### TECHNICAL FIELD

The present invention relates to integrated micro- and nano-scale devices and to techniques for analyzing biological material using such devices.

### BACKGROUND

When studying responses to stimulus, fluorescent imaging or electrophysiology of single cells is often used to measure the response. One such example of fluorescent imaging is the monitoring of cytosolic calcium with calcium dyes in response to an extracellular (administered outside the cell) (Grynkiewicz et al., 1985; Tsien and Gonzalez, 2002-2006) or intracellular (microinjected into the cell) stimulus (Schrlau et al., 2008b). Other fluorescent dyes are available for the monitoring of other cellular processes, such as intracellular sodium, potassium, chloride or pH indicators, cytosolic nitric oxide (NO), reactive oxygen species (ROS), cellular metabolism (for example, nicotinic adenine dinucleotide hydrogen (NADH) and flavin adenine dinucleotide (FAD)) (Invitrogen Handbook).

Electrophysiology is used to measure the membrane potential and ionic current of cells. Graham et al. (1946) and Ling et al. (1949) first showed how the resting membrane potential of muscle cells could be measured with electrolyte-filled glass micropipette. Using similar tools, Neher and Salrmann (1976) developed the patch clamp technique to study ion channels in frog muscle fibers which later earned them the Nobel Prize for the pioneering work. Electrolyte-filled glass pipettes find continued use in electrophysiology studies for a wide variety of cells (Dun et al., 1977; Brailoiu and Miyamoto, 2000).

For standard single cell analysis, the researcher first chooses the types of analysis to conduct. Often, fluorescent imaging with optical microscopes is combined with either glass-based microinjection or electrophysiology. In some rare instances with certain cells, all three can be done together but with a dramatic increase in experimental difficulty, cost, and failure. For fluorescent imaging of cellular processes, cells plated on cover slips or Petri dishes are incubated in a specific dye to monitor those process, such as Ca2⁺, pH, Na⁺, K⁺, Cl⁻, NO, or ROS dynamics. The cells are then placed onto an optical microscope equipped with a fluorescent system and micromanipulators. Depending on the desired function, glass micropipettes are purchased or fabricated in-house for either microinjection or electrophysiology. After the glass-based probes are prepared for use, the probes are fixed to a micromanipulator and moved into position. Under the optical microscope, the glass probe is brought into contact with the cell to perform its intended function such as injecting fluid into the cell with an injection system or electrically measure cell signals with a high sensitivity amplifier. Single cell analysis may involve a a variety of technologies, from different companies [Table 1].

Existing technology neither expedites single cell analysis nor facilitates the simultaneous measurement of multiple signals from a single cell. Other drawbacks of existing technology include, single-function (either used for injection or electrophysiology but not both), damaging to cells (either the probe is too big or multiple probes cause trauma), and fragility (break and clog easily). Understanding how a cell responds to extracellular or intracellular stimulus allows researchers unravel cellular process and is useful when discovering and developing drugs. However, current technology neither expedites single cell analysis nor facilitates the simultaneous measurement of multiple signals from a single cell.

### SUMMARY

Presented here are methods and devices for performing multiple cell physiology measurements on a single cell with a single probe. The present disclosure includes the use of a conductive micro- or nanopipette probe to inject fluids into biological materials (e.g., cells), measure the electrophysiological response of the material, and fluorescently monitor biological (e.g., cellular) processes; two or more of which can be conducted simultaneously. This presents advantages over current technology, allowing simple multi-point analysis on the same cell, real-time and fast-response data acquisition, minimal intrusion into the biological material, and increased efficiency of single cell analysis.

The present disclosure provides the use of, inter alia, conductive micro- and nano-pipette probes to simultaneously inject fluids into cells, measure the electrophysiological response of cells, and monitor cellular processes with fluorescent dyes. The ability to simultaneously perform multiple cell physiology measurements has significant advantages over doing them individually or interrogating the cell with multiple probes. Advantages include, simple multi-point analysis on the same cell, real-time and fast-response data acquisition, minimal intrusion of the cell, and increased probability of experimental/analytical success.

In a first aspect, the present disclosure provides methods of measuring a cellular property, comprising collecting, from a biological material having a membrane barrier, a first signal related to a property of the barrier; and a second signal related to a condition within the biological material.

In a second aspect, the present disclosure provides systems, comprising a reference electrode; a probe configured for insertion into a biological material; the probe comprising a sensing electrode configured to be disposed inside the biological material while a reference electrode is disposed exterior to the biological material; an injector configured to convey fluid into the biological material; and a monitoring device that monitors at least one or more signals from the sensing electrode, and a detector device capable of monitoring at least one optical signal from within the biological material.

### BRIEF DESCRIPTION OF THE DRAWINGS

The summary, as well as the following detailed description, is further understood when read in conjunction with the appended drawings. For the purpose of illustrating the invention, there are shown in the drawings exemplary embodiments of the invention; however, the invention is not limited to the specific methods, compositions, and devices disclosed. In addition, the drawings are not necessarily drawn to scale. In the drawings:

FIG. 1: Illustrates a schematic setup of an exemplary cell analysis technique combining fluorescence imaging, material delivery, and electrophysiology. Insert: Schematic showing the probe relative to the cell and cell membrane. Schematic not to scale.

FIG. 2: Schematic of a single probe with two conductive layers separated by an insulating template. Schematic not drawn to scale.

FIG. 3: Detecting electrical signals with a conducting probe. (A) A strategy for using the probe in cell experiments. (B) A close-up of how a probe penetrates a cell membrane and measures across the membrane with the intracellular electrode and extracellular reference electrode. (C) Actual voltage recording showing cell depolarization upon increases in extracellular potassium ion concentration.

FIG. 4: Cutaway schematic of a connector for the single probe. The probe is inserted into the connector (b-(i)) to interface with the conductive layers. The threaded clamping nut is then tightened (c-(ii)) to form a tight connection (c-(iii)) for fluid transfer. Schematic not to scale.

FIG. 5: An illustration of multi-point analysis of cellular processes. The probe is manipulated to penetrate the cell and form a gigaseal (a) while initial ratiometric calcium fluorescence images are captured (b). Concurrently, ratiometric calcium intensity data from selective regions on the image and cell membrane potential measurements are displayed (d). On command, fluid is injected through the probe into the cell as indicated by the “injection” line in (d). A fluorescence change is clearly visible only in the injected cell in the middle (c). The recorded ratiometric and electrical data are simultaneously acquired for multi-point analysis.

### DETAILED DESCRIPTION OF ILLUSTRATIVE EMBODIMENTS

The present invention may be understood more readily by reference to the following detailed description taken in connection with the accompanying figures and examples, which form a part of this disclosure. It is to be understood that this invention is not limited to the specific devices, methods, applications, conditions or parameters described and/or shown herein, and that the terminology used herein is for the purpose of describing particular embodiments by way of example only and is not intended to be limiting of the claimed invention. Also, as used in the specification including the appended claims, the singular forms “a,” “an,” and “the” include the plural, and reference to a particular numerical value includes at least that particular value, unless the context clearly dictates otherwise. Any documents cited herein are incorporated herein by reference in their entireties.

The term “plurality”, as used herein, means more than one. When a range of values is expressed, another embodiment includes from the one particular value and/or to the other particular value. Similarly, when values are expressed as approximations, by use of the antecedent “about,” it will be understood that the particular value forms another embodiment. All ranges are inclusive and combinable.

The present disclosure provides, inter alia, multiple-point measurement of cellular processes. Electrodes useful in the described methods include those based on conductive nanopipettes made from traditional glass micropipettes (Kim and Bau, 2005; Kim et al., 2005; Schrlau et al., 2008; Bau and Schrlau, 2008; U.S. patent application Ser. No. 11/231,425; U.S. patent application Ser. No. 12/897,207, all incorporated by reference herein in their entireties). The outer diameters of the nanopipette tips can range from tens of nanometers to a few micrometers. Carbon nanopipettes (CNPs) made by these techniques can inject fluids into epithelial cells (ca. 10 micrometers in diameter) without causing harm (Schrlau et al., 2008a).

CNPs were further utilized to identify unknown calcium signaling pathways in breast cancer cells by injecting calcium-mobilizing second messengers (Schrlau et al., 2008b). Fabricated with similar techniques, CWs were also able to electrically measure cell signals versus an extracellular reference electrode (Schrlau et al., 2009).

In a first aspect, provided are methods of measuring a cellular property. These methods include collecting, from a biological material having a membrane or other barrier, a first signal related to a property of the barrier; and a second signal related to a condition within the biological material.

The first and second signals may be collected simultaneously or at different times. The methods are suitably applied to virtually any biological material that includes a barrier (e.g., cell wall, cell membrane). Suitable biological materials include tissues, cells, nuclei, organelles, and the like. Cells are considered especially suitable candidates for the disclosed methods. Neurons, glia, skeletal muscle cells, smooth muscle cells, and the like (including other bodily tissues) are all considered suitable for the disclosed methods.

Barrier properties monitored by the disclosed methods include membrane potentials, as well as ionic transport across the membrane. In some embodiments, ionic transport is monitored by measuring membrane potential change or current generated across the membrane. Membrane potential of a cell is an indicator of the “health” of the cell in question. Every cell has a “resting” membrane potential. A deviation from the resting membrane potential indicates a perturbation of ion concentrations across the cell membrane, which is indicative of the cell's state. Na, K, Cl, and Ca are exemplary ions that may be monitored according to the present disclosure; other ions besides these may also be monitored, as this disclosure should not be understood as being limited to monitoring any particular ions.

In some embodiments, the user may measure, for example, a membrane potential or an ionic transport across the membrane by determining the potential difference between a reference electrode located in the environment exterior to the material (e.g., a cell) and an electrode located inside the cell. An amplifier may be used in such an assembly.

The methods may measure a variety of conditions inside the biological material, including, e.g., the concentration of an analyte. For example, the user may desire to know the concentration of a particular protein within a cell so as to assess the disease (or lack of disease) state in the cell. An analyte may be a biomolecule (e.g., a protein or a nucleic acid or acids), an ion, or some combination thereof. Ions that may be monitored include Na+. K+, Ca2+, Cl−, and the like. Ion-sensitive dyes (e.g., chloride sensitive dye), calcium-sensitive dyes, and voltage sensitive dyes (also known as potentiometric dyes; examples include substituted aminonaphthylethenylpyridinium (ANEP) dyes, such as di-4-ANEPPS, di-8-ANEPPS, and RH237) may be used to monitor ion concentration; the user may monitor the fluorescence of the dye inside the biological material and then correlate that value to a concentration.

One may also measure the ion concentration by measuring the current induced when ionic transport occurs across the membrane. Electrogenic sodium pumps, chloride pumps, and the like may transportions across the membrane. The analyte may be neutral in charge, positively charged, or negatively charged. The concentration of analyte may be determined or estimated by using a fluorescent dyes that specifically bind to analytes, by using molecular beacons, or by measuring the current flow across the barrier or membrane. Analyte-specific fluorescence dyes, fluorescent-labeled antibodies, and the like may all be used to detect and quantify the presence of an analyte. Suitable dyes include nucleic-acid probes (e.g., YOYO-1, SYTOX Blue™). Labeled antibodies include those that may have fluorescein, rhodamine, and the like conjugated thereto.

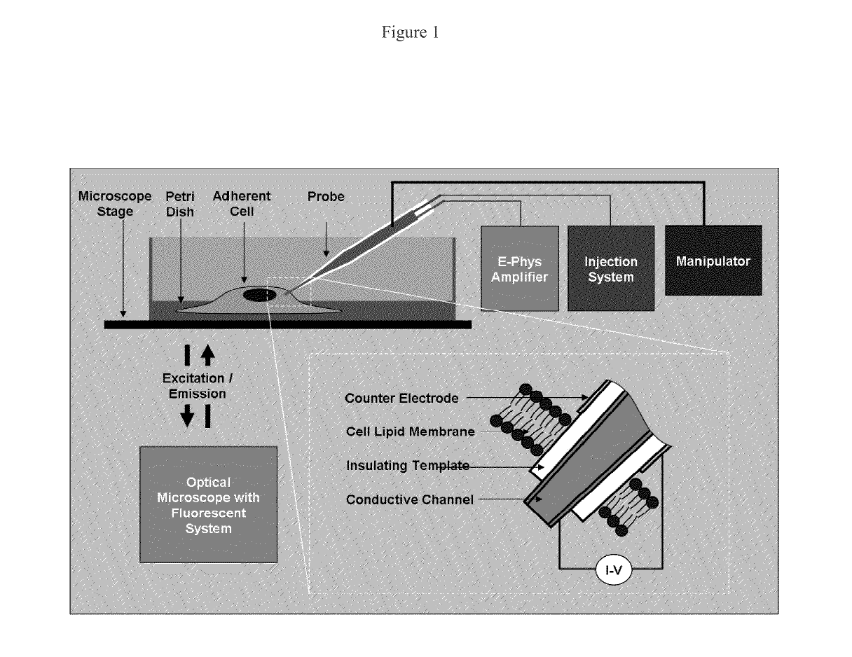

The user may collect with a single probe the signal related to a property of the barrier and the signal related to a condition within the biological material. This may be accomplished by a probe as described herein, where the probe is configured to include an electrode that remains within the biological material and an electrode that is configured to be outside the biological material during probe usage. One example is shown in FIG. 1, which illustrates a sensor probe inserted through a cell lipid membrane, with a conductive channel (acting as a sensing electrode) and a counter electrode disposed outside the cell lipid membrane.

Electrical signals in terms of voltage (ex: millivolts), amperage (ex: femtoseconds), resistance (ex: gigaohms), and as a function of time (ex: milliseconds), may all be monitored. Manufacturers of suitable amplifiers include include but not limited to HEKA, Axon, CHI, Bio-logic. Fluorescence imaging (ex: arbitrary units (a.u.) or converted into concentration (ex: nM), voltage (ex: mV), may be performed; Olympus Fluoview instruments are considered suitable for this purpose. Manufacturers of other equipment that may be used in the system include, but are not limited to, Eppendorf (Femtojet for pressure injection; Injectman and/or Transferman for probe manipulation/positioning), Harvard Apparatus (perfusion chambers that hold cultured cells during interrogation), and Renishaw spectrometer (Raman spectroscopy and analysis).

A user may inject (or aspirate) a material across the barrier of the biological material. This injection ma be accomplished by exerting the material through the lumen of a probe (e.g., the probe shown in FIG. 1) into the interior of the biological material. The material may be a fluid, that is, a suspension or mixture. The fluid may contain a dye, an antibody or antigen, or other material that may cause a change in a condition or function of the biological material. The material may include a protein (e.g., a biologically active protein), a peptide, or other synthetized compounds, including Angiotensin II, choline, mRNA, estrogens, progesterone, and the like. The user may monitor, as described in the examples, the signal related to a property of the barrier, the signal related to a condition within the biological material, or both, during injection of the material across the barrier of the biological material.

As one example, the user may inject an antibody into a cell to determine whether the cell contains a material reactive to the antibody. The user may determine this by monitoring the membrane potential of the cell before, during, or after the injection of the antibody. The user may also monitor a fluorescent signal inside the cell related to the presence of the antibody. This signal may be generated by fluorescent dyes that bind to the antibody or by sandwich assays or other techniques used to detect the presence of the antibodies.

The user may also inject a calcium-mobilizing second messenger into a cell to determine whether the cell is sensitive to the messenger and where in the cell the response occurs. The user may determine this by monitoring the membrane potential of the cell before, during, or after the injection of the messenger. The user may also monitor the fluorescent signal inside the cell related to the presence of the messenger. This signal may be generated by fluorescent dyes that shift and/or change their characteristic photon absorbance and/or emission in the presence of an ion, protein, etc. or binds to the messenger. In addition to messengers, the injected material can be proteins, DNA, nanoparticles, engineered biomolecules or any other injectable material and can be detected by molecular beacons, sandwich assays or other techniques used to detect the presence of these substances.

Also provided are systems. The disclosed systems suitably include a probe configured for insertion into a biological material, the probe comprising a sensing electrode configured to be disposed inside the biological material while a reference electrode is disposed exterior to the biological material; an injector configured to convey fluid into the biological material; a monitoring device that monitors at least one or more signals from the sensing electrode; and a detector device capable of monitoring at least one optical signal from within the biological material. Additional suitable systems include, for example, electrochemical amplifiers, scanning systems, optical fibers systems, and Raman spectrometers.

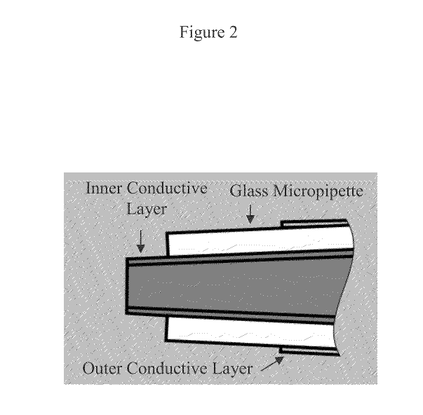

The probes suitably include an elongate hollow insulator having interior and exterior surfaces, at least a portion of the interior surface, the exterior surface, or both, being surmounted by a conductive material. Suitable probes may include a glass pulled pipette having conductive materials disposed on the inside and outside of the pipette. Such devices are described in U.S. patent application Ser. Nos. 11/231,425 and 12/897,207, both incorporated herein by reference in their entireties. The probe may define a lumen through which lumen material may be exerted (e.g., via injection) or withdrawn (e.g., via aspiration). The lumen may suitably have a diameter in the range of from about 5 nm to about 10 micrometers. One exemplary probe is shown in FIG. 2.

In some embodiments, the sensing electrode is defined by conductive material surmounting the interior surface of the elongate hollow insulator. This is illustrated by the “Conductive Channel” element in FIG. 1 and by the “Inner Conductive Layer” shown in FIG. 2. The conductive material may be carbon, a metal, a conducting polymer, and the like.

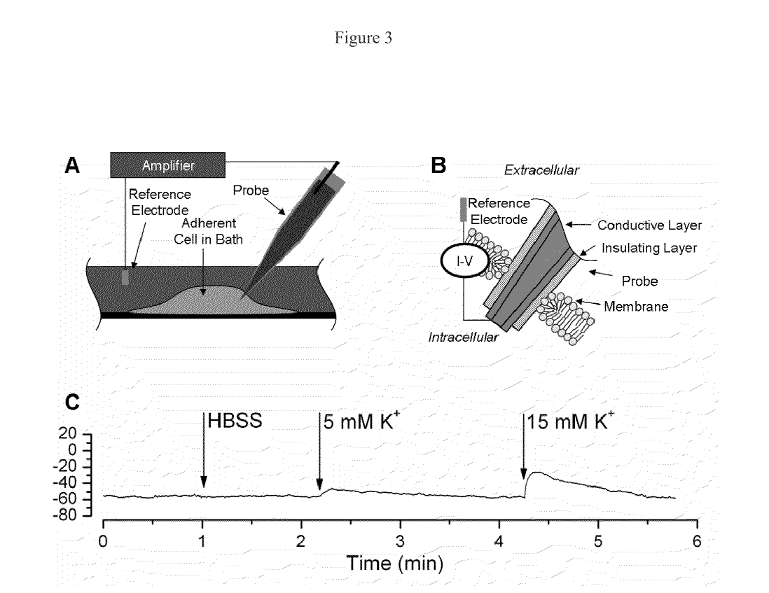

In some embodiments, the reference electrode is defined by conductive material surmounting the exterior surface of the elongate hollow insulator. This is illustrated by, e.g., the “Counter Electrode” shown in FIG. 1, or by the “Outer Conductive Layer” shown in FIG. 2. In some embodiments (e.g., FIG. 3A, 3B), the reference electrode is separate from the probe and is independently manipulable relative to the probe. In other embodiments, such as FIG. 2, the reference electrode is integrated into the probe itself. While the reference electrode is shown in FIG. 2 as an outer conductive layer surrounding the glass micropipette (or other dielectric material), the reference electrode need not necessarily be a layer; it can be a strip, a wire, or other configuration of conductive material.

In some embodiments, the conductive material surmounting the interior surface of the elongate hollow insulator is surmounted by a dielectric material (e.g., glass, polymer) that insulates the conductive material from a fluid carried within the lumen of the probe. The dielectric layer can be deposited with a variety of means including, but not limited to, chemical vapor deposition, electroless deposition, electrochemical cycling, and electrostatic layering.

The injector suitably exerts a fluid through the lumen of the probe. The probe may also be configured to aspirate material from the interior of the biological sample, which aspiration may be accomplished by running the injector in reverse. Typical systems that enable injection or aspiration include, but are not limited to, Eppendorf Femtojet, Sutter Picospritzer, or conventional syringes connected to a syringe pump (World Precision Instruments, WPI).

A monitoring device, such as an amplifier, is suitably in electronic communication with the sensing electrode, the reference electrode, or both. Electrophysiological and electrochemical amplifiers are considered suitable for this purposes. Other devices, including lasers, voltmeters, amplifiers, cameras, pressure transducers, computers, fluorometers, and the like, may be used to monitor another signal (such as a fluorescent signal) from the cell or other biological material under observation.

These capabilities may be combined with fluorescent imaging techniques [FIG. 1]. As shown in FIG. 1, a CNP or other hollow conductive probe can be simultaneously used with an injection system and electrophysiology amplifier during fluorescent imaging. As shown in the Inset of FIG. 1, the cell membrane forms a high resistance seal with the insulating template to enable both intracellular injection and electrical measurement.

The disclosed analyses and devices combines multiple, stand-alone cell physiology techniques, including fluorescence imaging, material delivery, and electrophysiology for cells of any type and size, as well as other biological material including tissues, organelles, and the like. The analysis can utilize a single, novel probe with multiple electrodes such as that described in, e.g., U.S. patent application Ser. No. 12/897,207, incorporated herein by reference. Such probes may include a glass micropipette or other insulating template with a conductive lining on the inner bore and a conductive layer on the outer surface [FIG. 2]. Conductive layers coat the glass micropipette so that electrical connections can be easily made at the distal end of the micropipette. To add functionality, the conductive probe tip may be be coated with proteins or oligonucleotides for selective analyte detection.

FIG. 3a shows an exemplary setup for electrophysiology with CNPs. FIG. 3b schematically depicts the position of the CNP relative to the cell during electrical measurement of a cell membrane potential. In this position, the CNP recorded a depolarization, in accordance with predictions from the Nernst equation, upon the extracellular administration of potassium [FIG. 3c]. It is in this electrical recording position that one may use a CNP or a similar conductive nanoprobe to simultaneously inject reagents into the cell to measure cell response and use fluorescent imaging to monitor other cell processes. Rather than using a separate external reference electrode as shown in FIG. 3, the reference electrode can be placed directly on the outside surface of the probe to provide a self-contained, single electrical probe. The single electrical probe configuration shown in FIG. 3 is described in U.S. patent application Ser. No. 12/897,207, incorporated herein by reference.

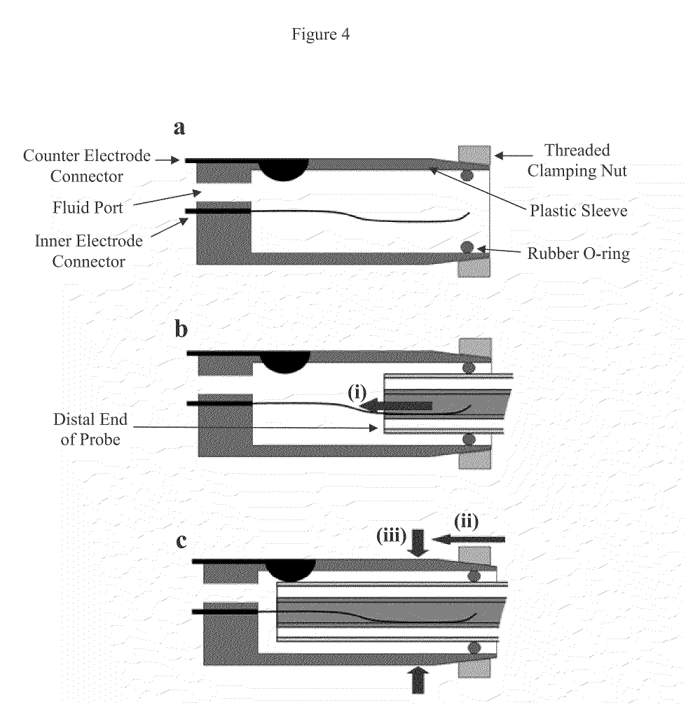

A typical multi-point analysis of cellular processes is conducted in the following manner. The probe is fastened to a holder having both fluid ports and electrical connections for one or multiple electrodes as shown in FIG. 4. An electrophysiology amplifier is electrically connected to the inner (and outer, if applicable) conductive layers and an injection system is connected to the hollow of the probe. At this stage, the novel probe facilitates concurrent injection/aspiration of fluids and electrical measurement. The device shown in FIG. 4 may be sized to accommodate typical glass capillaries (diameters are typically between 1.5 mm and 100 mm, but can be made to fit other sizes as necessary). The approximate overall size of the connector will be a few millimeters in outer diameter and a few centimeters long.

Fluorescent dye-loaded cells on cover slips or Petri dishes are placed on a vibration-isolated optical microscope equipped with a fluorescence system and manipulator. As shown in FIG. 3b, the probe is maneuvered so that only the inner conductive lining is inside the cell. At this position, a high resistance seal is formed between the insulating template and the cell membrane so that the resting membrane potential may be measured. Upon measuring a stable resting membrane potential, the user begins the multi-point analysis of cellular processes.

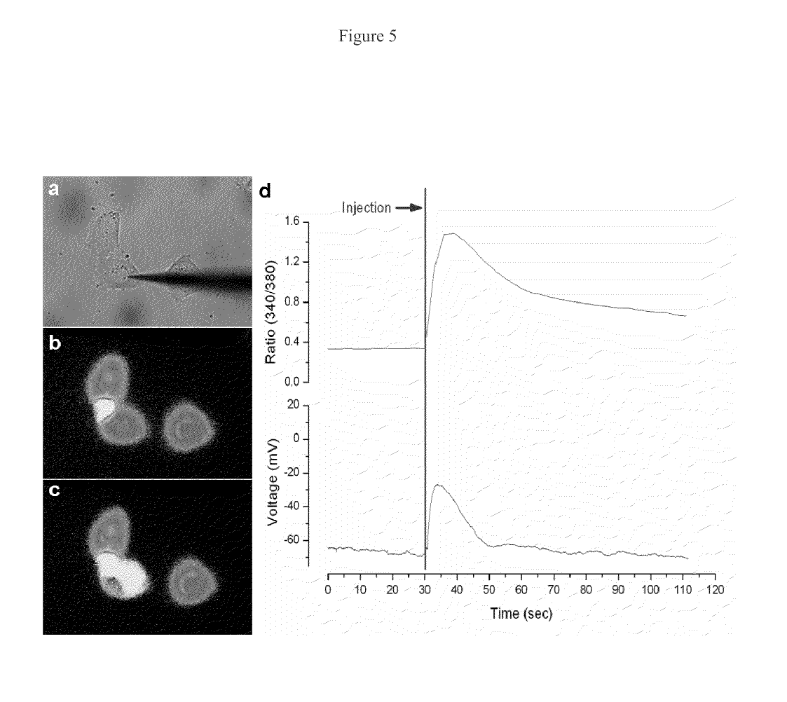

With the probe in position, the researcher may perform multi-point analysis on a single cell with one probe. As one example, the researcher can monitor concurrently the membrane potential and fluorescence intensity as a result of intracellular calcium release during intracellular injection of various calcium-mobilizing second messengers [FIG. 5]. FIG. 5a shows a probe interrogating the middle cell as depicted in FIG. 3b. The ratiometric fluorescent image depicted in FIG. 5b shows three cells at basal intracellular calcium levels (very low calcium concentration) while the probe electrically measures the stable resting membrane potential of the middle cell. In contrast, the ratiometric fluorescent image depicted in FIG. 5c shows intracellular calcium increased only in the middle cell upon injection of calcium-mobilizing second messengers. The non-injected cells remain at basal intracellular calcium levels.

FIG. 5d shows the quantified ratiometric intensity of the middle cell and its membrane potential during the injection process. As indicated by the vertical, labeled “injection” line in FIG. 5d, the injection of second messengers simultaneously elicited a transient release of intracellular calcium and a transient depolarization of membrane potential. A change of membrane potential is related to movements of ions across the cell membrane, which determines the membrane excitability/function of the cell in question.

The disclosed methods may be applied to monitor multiple cells or other samples. In this way, multiple probes—individually addressable—are used to monitor signals from multiple samples. This in turn enables the user to gather data from multiple samples in parallel, thus allowing the user to perform multiple experiments simultaneously. For example, a user might use two probes to simultaneously test the effect of a particular reagent on a control cell and a wild-type variant of that cell.

A variety of patent and non-patent documents are referenced herein. Each of these documents is incorporated herein by reference in its entirety for all purposes.

### REFERENCES

Brailoiu, E.; Miyamoto, M. D. Inositol trisphosphate and cyclic adenosine diphosphate-ribose increase quantal transmitter release at frog motor nerve terminals: possible involvement of smooth endoplasmic reticulum. Neuroscience 2000, 95, 927-31.
Dun, N. J.; Kaibara, K.; Karczmar, A. G. Dopamine and adenosine 3′,5′-monophosphate responses of single mammalian sympathetic neurons. Science 1977, 197, 778-780.
Graham J.; Gerald, R. W. Membrane potentials and excitation of impaled single muscle fibers. J. Cell. Comp. Physiol. 1946, 28, 99-117.
Grynluewicz, G.; Poenie, M.; Tsien, R. Y. A new generation of Ca2+ indicators with greatly improved fluorescence properties. J. Biol. Chem. 1985, 260, 3440-3450.
Kim, B. M.; Bau, H. H. A Method for Fabricating Integrated Nanostructures and Applications Thereof, Patent Application, ED1 15805 121US, 2005.
Kim, B. M.; Murray, T.; Bau, H. H. The Fabrication of Integrated Carbon Pipes with Sub Micron Diameters, Nanotechnology 2005, 16, 13 17-1320.
Ling, G.; Gerald, R. W. The normal membrane potential of frog sartorious fibers. J. Cell. Comp. Physiol. 1949, 34, 383-396.
Neher, E.; Salunann, B. Single-channel currents recorded from membranes of denervated frog muscle fibres. Nature 1976, 260, 799-802.
Schrlau, M. G.; Brailoiu, E.; Patel, S.; Gogotsi, Y.; Dun, N. J.; Bau, H. H. Carbon Nanopipettes Characterize Calcium Release Pathways in Breast Cancer Cells. Nanotechnology 2008b, 19, 325102.
Schrlau, M. G.; Dun, N. J.; Bau, H. H. Cell Electrophysiology with Carbon Nanopipettes. ACS Nano 2009, 3, 563-568.
Schrlau, M. G.; Falls, E. R.; Ziober, B. L.; Bau, H. H. Carbon Nanopipettes for Cell Probes and Intracellular Injection. Nanotechnology 2008a, 19, 01 5 101.
The Invitrogen Handbook, Web Edition—A guide to Fluorescent probes and labeling technologies, Tenth Edition, www.probes.comlhandbook.
Tsien, R. Y.; Gonzalez, 111, J. E. U.S. Pat. No. 6,342,379, Jan. 29, 2002, Detection of transmembrane potentials by optical methods.
Tsien, R. Y.; Gonzalez, 111, J. E. U.S. Pat. No. 7,087,416, Aug. 8, 2006, Detection of transmembrane potentials by optical methods.
Tsien, R. Y.; Gonzalez, 111, J. E. U.S. Pat. No. 7,115,401, Oct. 3, 2006, Detection of transmembrane potentials by optical methods.
Tsien, R. Y.; Gonzalez, 111, J. E. U.S. Pat. No. 7,118,899, Oct. 10, 2006, Detection of transmembrane potentials by optical methods

TABLE 1
Table 1: Single Cell Analysis Capabilities and the Companies that Supply Them

| Companies | Single Cell Analysis Capabilities | | | | | | |
|---|---|---|---|---|---|---|---|
| that Supply | Optical | Fluorescence | Glass and | Fluorescent | Manipulator | Injection | E-Physiology |
| Technology | Microscope | System | Pullers | Dyes | System | System | System |
| Olympus | X | X | | | | | |
| Nikon | X | X | | | | | |
| Leica | X | X | | | | | |
| Sutter | | X | X | | X | | |
| Invitrogen | | | | X | | | |
| Eppendorf | | | X | | X | X | |
| Narishige | | | | | X | | |
| HEKA | | | | | | | X |
| Axon | | | | | | | X |

What is claimed:

1. A method of measuring a cellular property, comprising:
collecting, from a biological material having a membrane barrier,
(a) a first signal related to a property of the barrier; and
(b) a second signal related to a condition within the biological material.

2. The method of claim 1, wherein the first and second signals are collected simultaneously.

3. The method of claim 1, wherein the biological material comprises a tissue, cell, nucleus, organelle, or any combination thereof.

4. The method of claim 1, wherein the property comprises a membrane potential, an ionic transport across the membrane, or both.

5. The method of claim 4, wherein the membrane potential or ionic transport across the membrane is measured by determining the potential difference between a reference electrode located in the environment exterior to the cell and an electrode located inside the cell.

6. The method of claim 1, wherein the condition comprises the concentration of an analyte.

7. The method of claim 6, wherein the analyte comprises a biomolecule, an ion, or any combination thereof.

8. The method of claim 1, wherein the signal related to a property of the barrier and the signal related to a condition within the biological material are collected by a single probe.

9. The method of claim 1, further comprising injecting, aspirating, or both, a material across the barrier of the biological material.

10. The method of claim 9, wherein the material comprises a protein, a peptide, a chemically synthetized compound, or any combination thereof.

11. The method of claim 9, further comprising monitoring the signal related to a property of the barrier, the signal related to a condition within the biological material, or both, during injection of the material across the barrier of the biological material.

12. A system, comprising:
a reference electrode;
a probe configured for insertion into a biological material;
the probe comprising a sensing electrode configured to be disposed inside the biological material while a reference electrode is disposed exterior to the biological material;
an injector configured to convey fluid into the biological material;
a monitoring device that monitors at least one or more signals from the sensing electrode;
a detector device capable of monitoring at least one optical signal from within the biological material.

13. The system of claim 12, wherein the probe comprises an elongate hollow insulator having interior and exterior surfaces, at least a portion of the interior surface, the exterior surface, or both, being surmounted by a conductive material.

14. The system of claim 13, wherein the probe defines a lumen, the lumen having an internal diameter in the range of from about 5 nm to about 10 micrometers.

15. The system of claim 13, wherein the conductive material surmounting the interior surface of the elongate hollow insulator defines the sensing electrode.

16. The system of claim 15, wherein the conductive material surmounting the exterior surface of the elongate hollow insulator defines the reference electrode.

17. The system of claim 13, wherein the probe comprises the injector.

18. The system of claim 13, wherein conductive material surmounting the interior surface of the elongate hollow insulator is surmounted by a first dielectric material.

19. The system of claim 12, wherein the monitoring device is in electronic communication with the sensing electrode, the reference electrode, or both.

20. The system of claim 12, wherein the detector device comprises a specialized electrode, an image capturing device, an injector, flurometer, an amplifier, laser, or any combination thereof.
